(19) United States
(12) Patent Application Publication
(10) Pub. No.: US 2019/0228169 A1
(43) Pub. Date: Jul. 25, 2019

(54) MEMORY CONTROL DEVICE AND MEMORY CONTROL METHOD

(71) Applicant: MStar Semiconductor, Inc., Hsinchu Hsien (TW)

(72) Inventor: Chien-Hsing HUANG, Hsinchu Hsien (TW)

(21) Appl. No.: 16/045,808

(22) Filed: Jul. 26, 2018

(30) Foreign Application Priority Data
Jan. 19, 2018 (TW) 107102114

(51) Int. Cl. G06F 21/62; G06F 12/02

(52) U.S. Cl. CPC G06F 21/6209; G06F 2212/651; G06F 12/0292

(57) ABSTRACT

A memory control device and a memory control method. The memory control method includes: receiving a physical address of a memory from a function circuit; searching a lookup table according to the physical address to determine a range identifier; searching a permission lookup table according to a device identifier corresponding to the function circuit and the range identifier to determine an operation permission of the function circuit for operating the physical address of the memory.

This application claims the benefit of Taiwan application Serial No. 107102114, filed Jan. 19, 2018, the subject matter of which is incorporated herein by reference.

### BACKGROUND OF THE INVENTION

### Field of the Invention

The invention relates to a memory control device and a memory control method, and more particularly to a memory control device and a method control method associated with permission control.

### Description of the Related Art

With the progressing technologies, various constantly innovating electronic products have become available. Many electronic products are equipped with various function circuits to realize various functions. Under the consideration of information security, a system needs to control operation permissions of function circuits.

Conventionally, a memory is divided into two regions, one of which is assigned with full access permission (readable and writable), and the other is assigned with partial access permission (only readable or only writable). Each function circuit is configured to correspond to one of the regions, for example, a decoding circuit corresponds to the memory region with a full access permission, and a network access circuit corresponds to the memory region which permits only write operations.

However, merely dividing a memory into two regions does not enable a system to appropriately plan the use of the memory, for example, the memory cannot be flexibly utilized under the premise of also attending to security.

### SUMMARY OF THE INVENTION

The invention is directed to a memory control device and a memory control method, which configure a memory into multiple domains according to the number of function circuits, with the function circuits respectively corresponding to the domains. Each function circuit has a corresponding operation permission for operating each domain. Thus, each function circuit is enabled to flexibly plan the corresponding domain without being restrained to a planning means of two regions as that in the prior art.

According to an aspect of the present invention, a memory control method is provided. The memory control method includes: receiving a physical address of a memory from a function circuit; searching a lookup table according to the physical address to determine a range identifier; searching a permission lookup table according to a device identifier corresponding to the function circuit and the range identifier to determine an operation permission of the function circuit for operating the physical address of the memory.

According to another aspect of the present invention, a memory control device is provided. The memory control device includes a range processing circuit and a permission processing circuit. The range processing circuit receives a physical address of a memory from a function circuit, and searches a range lookup table according to the physical address to obtain a range identifier. The permission processing circuit searches a permission lookup table according to a device identifier corresponding to the function circuit and the range identifier to determine an operation permission of the function circuit for operating the physical address of the memory.

According to another aspect of the present invention, a memory control method is provided. The memory control method includes: receiving a physical address of a memory from a function circuit, which is a processor; receiving a secure environment indication signal from the function circuit; determining whether the function circuit is in a secure environment mode according to the secure environment indication signal; if the function circuit is in the secure environment mode, the function circuit directly operating the physical address of the memory; if the function circuit is not in the secure environment mode, determining an operation permission of the function circuit for operating the physical address of the memory, and the function circuit operating the physical address of the memory according to the operation permission.

According to yet another aspect of the present invention, a memory control device is provided. The memory control device includes a secure environment determining circuit and a permission processing circuit. The secure environment determining circuit receives a physical address from a function circuit, and receives a secure environment indication signal from the function circuit, wherein the function circuit is a processor. The secure environment determining circuit determines whether the function circuit is in a secure environment mode according to the secure environment indication signal. If the function circuit is in the secure environment mode, the function circuit directly operates the physical address of the memory. If the function circuit is not in the secure environment mode, the permission processing circuit determines an operation permission of the function circuit for operating the physical address of the memory, and the function circuit then operates the physical address of the memory according to the operation permission.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a memory control device according to an embodiment of the present invention;

FIG. 2 is a flowchart of a memory control method according to an embodiment of the present invention;

FIG. 3 is a schematic diagram of a memory control device according to another embodiment of the present invention;

FIG. 4 is a flowchart of a memory control method according to another embodiment of the present invention;

FIG. 5 is a schematic diagram of a range lookup table;

FIG. 6 is a schematic diagram of a memory control device according to another embodiment of the present invention;

FIG. 7 is a flowchart of a memory control method according to another embodiment of the present invention;

FIG. 8 is a schematic diagram of a screening lookup table;

FIG. 9 is a schematic diagram of a memory control device according to another embodiment of the present invention; and

FIG. 10 is a flowchart of a memory control method according to another embodiment of the present invention.

### DETAILED DESCRIPTION OF THE INVENTION

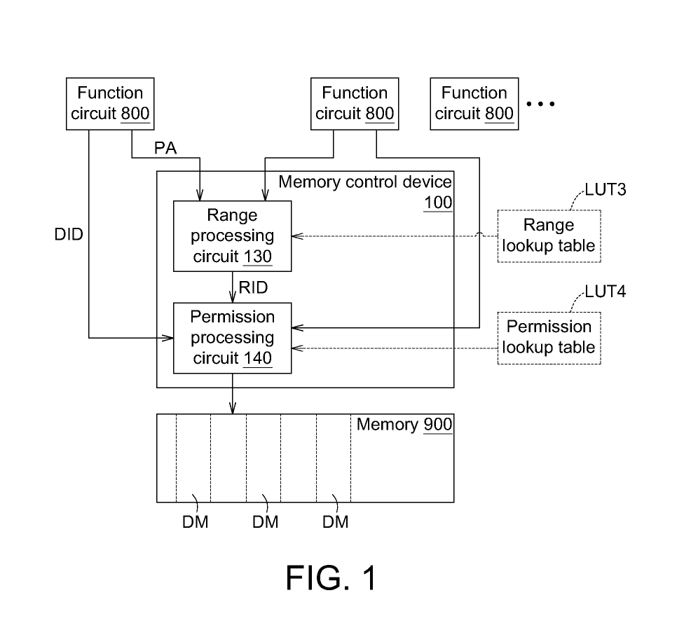

FIG. 1 shows a schematic diagram of a memory control device 100 according to an embodiment of the present invention. The memory control device 100 includes a range processing circuit 130 and an operation permission processing circuit 140. Each domain of a memory 900 has a physical address PA, and a function circuit 800 uses the physical address PA to represent a domain of the memory 900 that the function circuit 800 is to operate. In this embodiment, the function circuit 800 provides the physical address PA for the range processing circuit 130 and the permission processing circuit 140 to accordingly determine an operation permission of the function circuit 800 for operating the physical address PA. For example, the function circuit 800 is a central processing unit executing an operating system, a video processor, or a graphics processor. For example, the range processing circuit 130 and the permission processing circuit 140 are a chip, a circuit board, a circuit module in a chip, or a storage circuit storing multiple codes. Operation details of the components above are given with reference to a flowchart below.

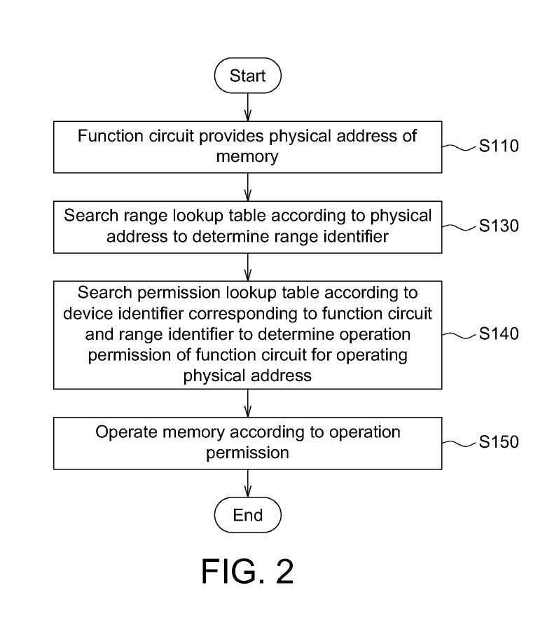

FIG. 2 shows a flowchart of a memory control method according to an embodiment of the present invention. In this embodiment, the memory 900 is configured to have multiple domains DM. In this embodiment, each domain DM corresponds to a range identifier (RID). In other embodiments, multiple domains DM may correspond to one range identifier RID, and each function circuit 800 may correspond to one or multiple domains DM. Each function circuit 800 has a corresponding operation permission for each domain DM, e.g., a full access permission (readable and writable) or a partial access permission (readable only or writable only). Thus, the system may flexibly plan each function circuit 800 and the corresponding domain DM, and is not limited to the conventional planning method of two regions.

As shown in FIG. 2, in step S110, the function circuit 800 provides the physical address PA of the memory 900 to the range processing circuit 130. More specifically, when the system is to control the function circuit 800 to operate the physical address PA of the memory 900, the function circuit 800 first transmits the physical address PA to the range processing circuit 130.

In step S130, the range processing circuit 130 searches a range lookup table LUT3 according to the physical address PA to obtain a range identifier RID. The range lookup table LUT3 may be stored in the memory 900 or be stored in another storage device. Table-1 shows an example of the range lookup table LUT3. The range identifier RID corresponds to a continuous range from a starting address to an ending address in the memory 900. The range processing circuit 130 searches the range lookup table LUT3 to learn between which starting address and which ending address the physical address PA is located, and can correspondingly find the range identifier RID.

TABLE 1

| | | Range identifier RID | | | | | | |
|---|---|---|---|---|---|---|---|---|
| | | RA | RB | RC | RD | RE | RF | RG |
| Physical address | Start | 0x100 | 0x300 | . . . | . . . | . . . | . . . | 0x800 |
| PA | End | 0x200 | 0x400 | . . . | . . . | . . . | . . . | 0x900 |

In step S140, the permission processing circuit 140 searches a permission lookup table LUT4 according to the range identifier RID and a device identifier DID provided by the function circuit 800 to determine an operation permission of the function circuit 800 for operating the physical address PA. The permission lookup table LUT4 may be stored in the memory 900 or be stored in another storage device. Table-2 shows an example of the permission lookup table LUT4. In one embodiment, the operation permission may be represented by two codes (e.g., two bits). For example, the first code represents a write permission (“0” representing non-writable and “1” representing writable), and the second code represents a read permission (“0” representing non-readable and “1” representing readable). For example, “00” represents non-writable and non-readable, “01” represents non-writable but readable, “10” represents writable but non-readable, and “11” represents writable and readable.

TABLE 2

Device identifier DID

| | | DA | DB | DC | DD | DE | . . . |
|---|---|---|---|---|---|---|---|
| Range | RA | 00 | 01 | 10 | 11 | 01 | . . . |
| identifier | RB | 00 | 01 | 10 | 11 | 01 | . . . |
| RID | RC | 00 | 01 | 10 | 11 | 01 | . . . |
| | RD | 00 | 01 | 10 | 11 | 01 | . . . |
| | RE | 00 | 01 | 10 | 11 | 01 | . . . |
| | . . . | . . . | . . . | . . . | . . . | . . . | . . . |

In step S150, the memory control device 100 operates the memory 900 according to the operation permission. With the above embodiments, the system can flexibly plan the domain DM in the memory 900 corresponding to each function circuit 800, and then find the corresponding operation permission from the range lookup table LUT3 and the permission lookup table LUT4. Thus, the planning of the memory 900 becomes more flexible.

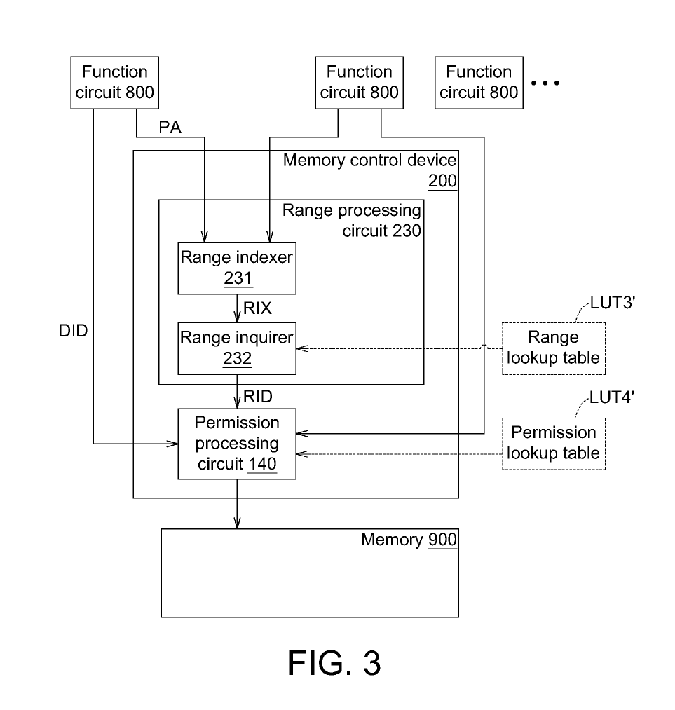

FIG. 3 shows a schematic diagram of a memory control device 200 according to another embodiment of the present invention. The memory control device 200 of this embodiment differs from the memory control device 100 by a range processing circuit 230, and other identical details are not repeated herein. In this embodiment, to further enhance the planning flexibility of the memory 900, multiple non-consecutive pages in the memory 900 may be planned to form one domain DM. For example, the size of each page is 4 KB.

The range processing circuit 230 includes a range indexer 231 and a range inquirer 232. Operation details of the components are given with reference to a flowchart below.

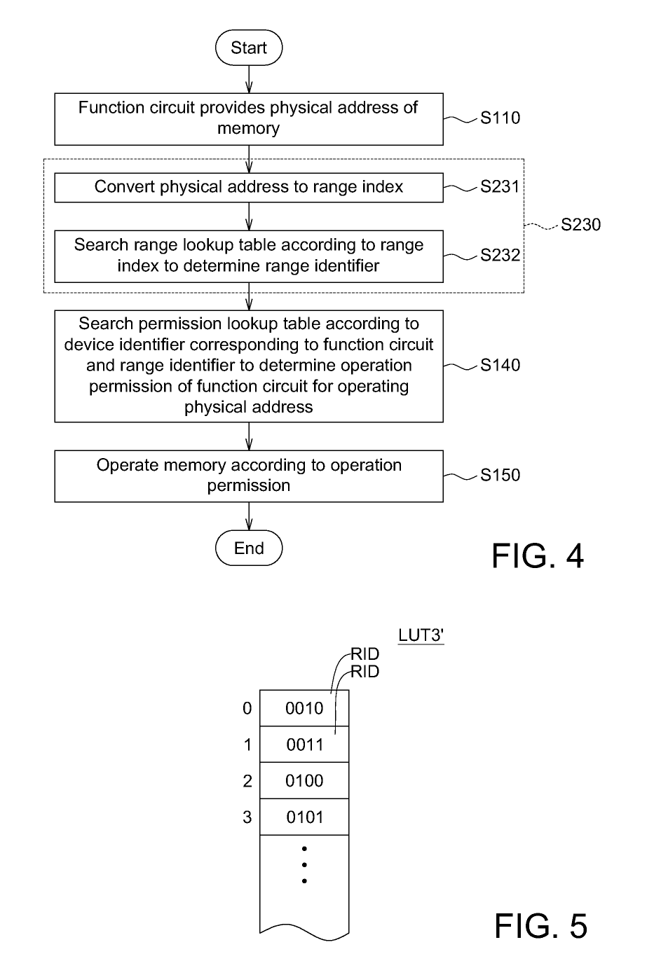

FIG. 4 shows a flowchart of a memory control method according to another embodiment of the present invention. In this embodiment, step S230 includes step S231 and step S232. In step S231, the range indexer 231 receives the physical address PA, and converts the physical address PA to a range index RIX, wherein each range index RIX corresponds to the range of one page. For example, the range indexer 231 calculates the range index according to equation (1) below:

$$Range index RIX = \frac{Physical address PA}{4 K} - 1 \qquad ( 1 )$$

In step S232, the range inquirer 232 searches a range lookup table LUT3′ according to the range index RIX to obtain the range identifier RID. FIG. 5 shows a schematic diagram of the range lookup table LUT3′. As shown in FIG. 5, each range index RIX corresponds to one range identifier RID. In this embodiment, assuming that the memory 900 is divided into 16 domains DM (each domain DM consisting of non-consecutive pages), 4 bits are needed to represent 16 different range identifiers RID. For example, the range identifier RID “0001” can be found from the range index RIX “1”, and the range identifier RID “0100” can be found from the range index RIX “2”.

Different function circuits have different device identifiers DID. After the range identifier RID is identified, in step S140, the permission processing circuit 140 searches the permission lookup table LUT4 according to the device identifier DID and the range identifier RID to determine the operation permission of the function circuit 800 for operating the physical address PA.

Similarly, in step S150, the memory control device 200 can operate the memory 900 according to the operation permission. With the above embodiment, each function circuit 800 is able to flexibly plan multiple non-consecutive pages to form one domain DM in the memory 900, and then find the corresponding operation permission by searching the range lookup table LUT3′ and the permission lookup table LUT4. Thus, the planning of the memory 900 becomes more flexible. However, taking a 4G memory 900 for instance, approximately 1048576 pages are included, i.e., 1048576 range indices RIX need to be recorded. Assuming that the memory 900 is to be divided into 16 domains DM, each range identifier RID requires at least four bits. In the above situation, the memory space needed by the range lookup table LUT3′ is enormous.

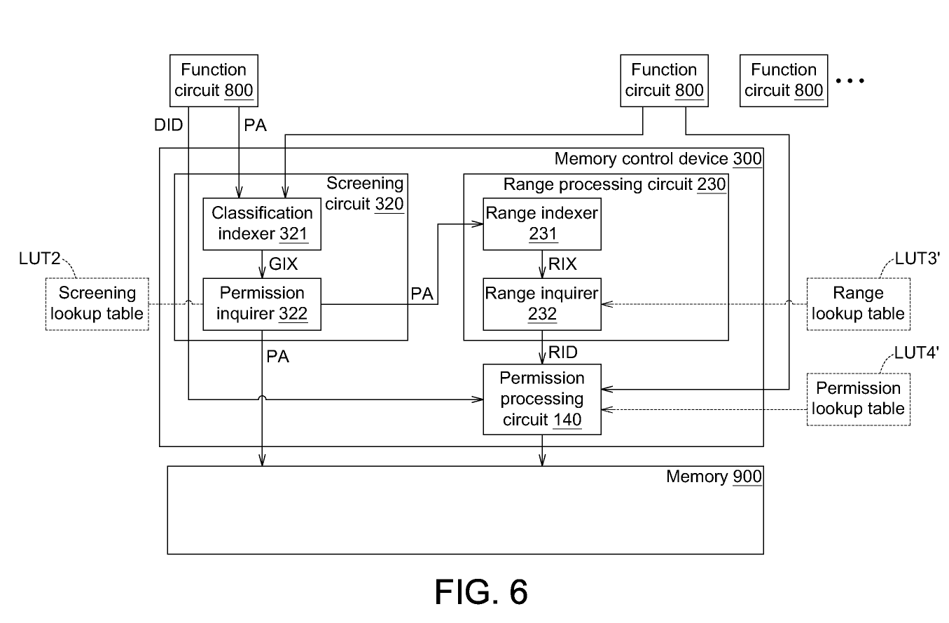

FIG. 6 shows a schematic diagram of a memory control device 300 according to another embodiment of the present invention. The memory control device 300 of this embodiment differs from the memory control device 200 by further including a screening circuit 320, and other identical details are not repeated herein. In this embodiment, to further accelerate the processing speed, before the permission is determined, screening is first performed to select physical addresses PA having a partial access permission, and determination is performed on only these physical address so as to reduce the processing time.

The screening circuit 320 includes a classification indexer 321 and a permission inquirer 322. Operation details of the components are given with reference to a flowchart below.

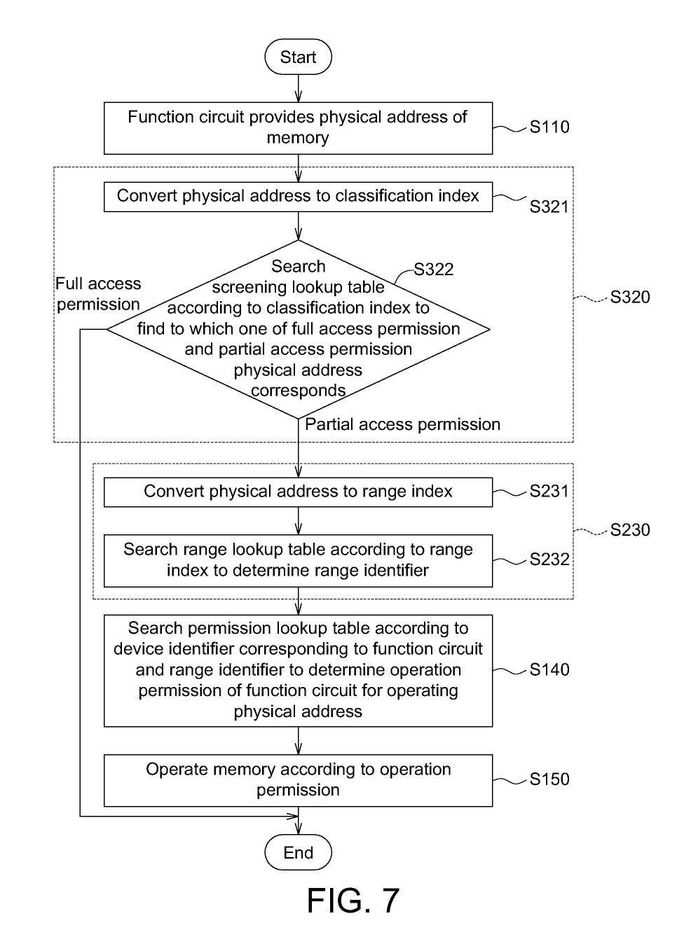

FIG. 7 shows a flowchart of a memory control method according to another embodiment of the present invention. In this embodiment, step S320 is further performed before step S230. In step S320, the screening circuit 320 searches a screening lookup table LUT2 according to the physical address PA to analyze whether the physical address PA provided by the function circuit 800 corresponds to a full access permission or a partial access permission. The screening lookup table LUT2 may be stored in the memory 900 or be stored in another storage device. Step S320 includes Step S321 and Step S322. In step S321, the classification indexer 321 converts the physical address PA to a classification index GIX, wherein each classification index GIX corresponds to a memory range of a specific size, e.g., a 1 MB range. At this point, the classification indexer 321 calculates the classification index GIX according to equation (2) below:

$$Classification index GIX = \frac{Physical address PA}{1 M} - 1 \qquad ( 2 )$$

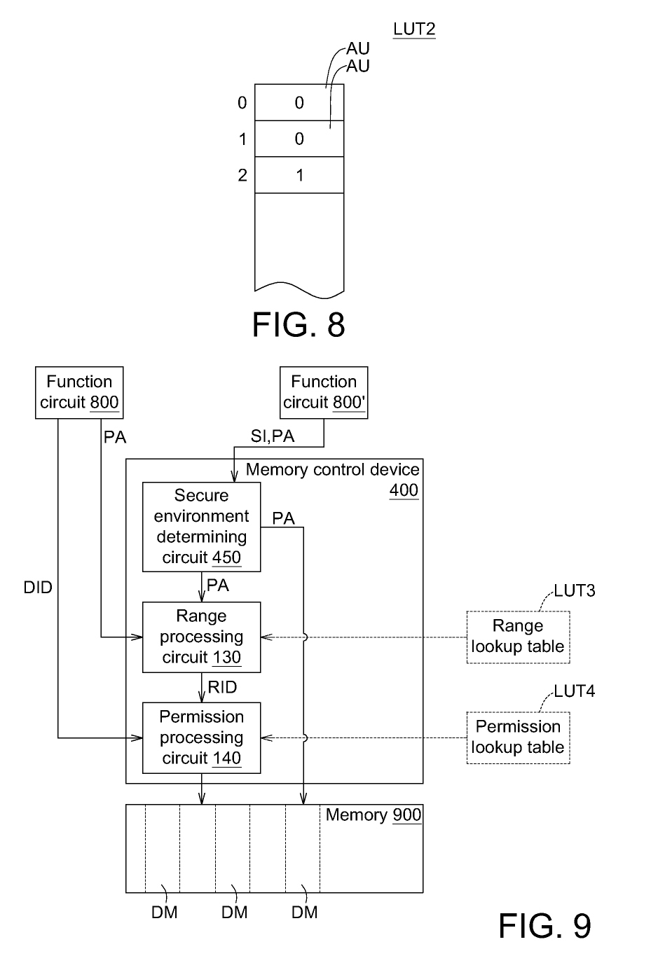

In step S322, the permission inquirer 322 searches the screening lookup table LUT2 according to the classification index GIX to find to which one of the full access permission and the partial access permission the physical address PA corresponds. FIG. 8 shows a schematic diagram of the screening lookup table LUT2. As shown in FIG. 8, each classification index GIX corresponds to one permission value AU. The permission value AU is denoted by only one bit. For example, the permission value AU “0” can be found from the classification index GIX “1”, and the permission value AU “1” can be found from the classification index GIX “2”. A permission value AU in “0” indicates a partial access permission and a permission value AU in “1” indicates a full access permission.

If the physical address PA corresponds to a partial access permission, the physical address PA is transmitted to the range processing circuit 230 to continue the permission analysis. Step S230 is performed after the physical address PA is transmitted to the range processing circuit 230. Step S230 is identical to that described previously, and is not repeated herein.

If the physical address PA corresponds to a full access permission, the function circuit 800 is directly allowed to operate, e.g., read or write, the memory 900 according to the physical address PA. Thus, the screening step (step S320) performed for permission processing is able to select the physical address PA having a full access permission, and the subsequent step S234 and step S240 of permission analysis on these physical addresses can be skipped, thus reducing the processing time. With the embodiment in FIG. 6, the part of the memory with a full access permission is no longer required to be stored in the range lookup table LUT3′ and the permission lookup table LUT4, thus resolving the issue of an enormous memory space needed by the range lookup table LUT3′ in the embodiment in FIG. 3. For example, if only 512 MB in the 4G memory 900 needs a limited permission, the embodiment in FIG. 6 can save the storage space for storing a lookup table by ⅞. In other embodiment, the screening lookup table LUT2 may be directly established in an SRAM. Because the screening lookup table LUT2 contains data that needs to be searched in the embodiment in FIG. 6, directly establishing the screening lookup table LUT2 in an SRAM significantly reduces the delay in reading a DRAM. Although an SRAM is more costly than a DRAM, no significant increase in production costs is caused because the screening lookup table LUT2 needs only a minimal space.

FIG. 9 shows a schematic diagram of a memory control device 400 according to another embodiment of the present invention. The memory control device 400 of this embodiment differs from the memory control device 100 by further including a secure environment determining circuit 450, and in that one function circuit 800′ is a processor; the other identical parts are not repeated herein. In this embodiment, the function circuit 800′ is a processor, and has a function of switching between a secure environment mode and a non-secure environment mode. The function circuit 800′ has a full access permission when the function circuit 800′ is in a secure environment mode; when the function circuit 800′ is in a non-secure environment mode, the function circuit 800′ needs to activate a corresponding permission through the above control method. Operation details of the components are given with reference to a flowchart below.

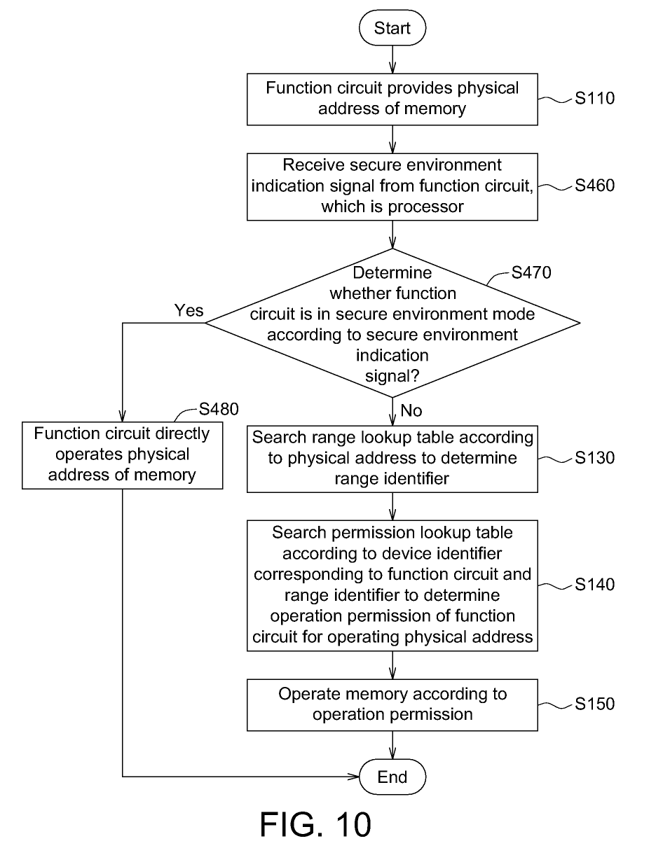

FIG. 10 shows a flowchart of a memory control method according to another embodiment of the present invention. In this embodiment, step S460 is further performed before step S110. In step S460, the secure environment determining circuit 450 receives a secure environment indication signal SI from a function circuit 800′. For example, the function circuit 800′ is a processor.

In step S470, the secure environment determining circuit 450 determines whether the function circuit 800′ is in a secure environment according to the secure environment indication signal SI.

If the function circuit 800′ is in a secure environment mode, step S480 is performed. If the function circuit 800′ is not in a secure environment mode, step S130 is performed. The details of the process after step S130 are identical to those described previously, and are not repeated herein.

In step S480, the function circuit 800′ can directly operate the physical address PA of the memory 900. Thus, when the function circuit 800′ is in a secure environment mode, the function circuit 800′ is allowed with a full access permission to the memory 900.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory control method, comprising:
receiving a physical address of a memory from a function circuit;
searching a range lookup table according to the physical address to determine a range identifier; and
searching a permission lookup table according to a device identifier corresponding to the function circuit and the range identifier to determine an operation permission of the function circuit for operating the physical address of the memory.

2. The memory control method according to claim 1, wherein the range identifier corresponds to an interval of the memory.

3. The memory control method according to claim 1, wherein the operation permission includes at least one of a read permission and a write permission.

4. The memory control method according to claim 1, wherein the step of searching the range lookup table comprises:
converting the physical address to a range index, which corresponds to a range of one page of the memory; and
searching the range lookup table according to the range index to determine the range identifier.

5. The memory control method according to claim 1, further comprising:
searching a screening lookup table according to the physical address to determine to which one of a full access permission and a partial access permission the physical address corresponds, and performing the step of searching the range lookup table according to the physical address to obtain the range identifier if the physical address corresponds to the partial access permission.

6. The memory control method according to claim 5, wherein the step of searching the screening lookup table according to the physical address to determine to which one of the full access permission and the partial access permission the physical address corresponds comprises:
converting the physical address to a classification index, which corresponds to a memory range of a predetermined size; and
searching the screening lookup table according to the classification index to find to which one of the full access permission and the partial access permission the physical address corresponds.

7. The memory control method according to claim 1, further comprising:
receiving a secure environment indication signal from the function circuit, wherein the function circuit is a processor;
determining whether the function circuit is in a secure environment mode according to the secure environment indication signal; and
if the function circuit is in the secure environment mode, the function circuit directly operating the physical address of the memory.

8. The memory control method according to claim 1, wherein the secure environment indication signal is a non-secure bit.

9. A memory control device, comprising:
a range processing circuit, receiving a physical address of a memory from a function circuit, and searching a range lookup table according to the physical address to obtain a range identifier; and
a permission processing circuit, searching a permission lookup table according to a device identifier corresponding to the function circuit and the range identifier to determine an operation permission of the function circuit for operating the physical address of the memory.

10. The memory control device according to claim 9, wherein the range identifier corresponds to an interval of the memory.

11. The memory control device according to claim 9, wherein the operation permission includes at least one of a read permission and a write permission.

12. The memory control device according to claim 9, wherein the range processing circuit comprises:
a range indexer, converting the physical address to a range index, which corresponds to a range of one page of the memory; and
a range inquirer, searching the range lookup table according to the range index to determine the range identifier.

13. The memory control device according to claim 9, further comprising:
a screening circuit, coupled between the function circuit and the range processing circuit, searching a screening lookup table according to the physical address to determine to which one of a full access permission and a partial access permission the physical address corresponds, and transmitting the physical address to the range processing circuit if the physical address corresponds to the partial access permission.

14. The memory control device according to claim 13, wherein the screening circuit comprises:
a classification indexer, converting the physical address to a classification index, which corresponds to a memory range of a predetermined size; and
a permission inquirer, searching the screening lookup table according to the classification index to determine to which one of the full access permission and the partial access permission the physical address corresponds.

15. The memory control device according to claim 9, further comprising:
a secure environment determining circuit, receiving a secure environment indication signal from the function circuit, wherein the function circuit is a processor, the secure environment determining circuit determining whether the function circuit is in a secure environment mode according to the secure environment indication signal, and the function circuit directly operating the physical address of the memory if the function circuit is in the secure environment mode.

16. The memory control device according to claim 15, wherein the secure environment indication signal is a non-secure bit.

17. A memory control device, comprising:
a secure environment determining circuit, receiving a physical address of a memory from a function circuit, and receiving a secure environment indication signal from the function circuit, wherein the function circuit is a processor, the secure environment determining circuit further determining whether the processor is in a secure environment mode according to the secure environment indication signal, wherein the function circuit directly operates the physical address of the memory if the processor is in the secure environment mode; and
a permission processing circuit, if the function circuit is not in the secure environment mode, the permission processing circuit determining an operation permission of the function circuit for operating the physical address of the memory, wherein the function circuit operates the physical address of the memory according to the operation permission.

18. The memory control device according to claim 17, wherein the secure environment indication signal is a non-secure bit.

19. The memory control device according to claim 17, further comprising:
a range processing circuit, searching a range lookup table according to the physical address to determine a range identifier;
wherein, the permission processing circuit searches a permission lookup table according to a device identifier corresponding to the function circuit and the range identifier to determine the operation permission of the function circuit for operating the physical address of the memory.
